(19) United States
(12) Patent Application Publication
(10) Pub. No.: US 2006/0092464 A1
(43) Pub. Date: May 4, 2006

(54) Printing apparatus, printing control method, printing control program and computer-readable recording medium recording the same

(76) Inventor: Hiroyuki Ataka, Nara-shi (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/263,108

(22) Filed: Oct. 31, 2005

(30) Foreign Application Priority Data
Nov. 1, 2004 (JP) 2004-318457

(51) Int. Cl. G06F 3/12

(52) U.S. Cl. 358/1.15

(57) ABSTRACT

A printing apparatus that can reduce a burden on the user when printing related jobs is provided. A job queue stores a plurality of received print jobs, and the received print jobs are printed by a print portion. A job status notification processing portion notifies an information terminal apparatus which sent the print jobs, of the status of output of the print jobs. In the case of notifying the information terminal apparatus of the status of the print jobs determined to be the related jobs by a related job determining portion, the information terminal apparatus which sent the print job is notified of that the print jobs are the related jobs.

### BACKGROUND OF THE INVENTION

1. Field of the Invention

The present invention relates to a printing apparatus which receives a print job from an information terminal apparatus and outputs the received print job by printing, a printing control method that controls the printing apparatus, a printing control program, and a computer-readable recording medium recording the printing control program.

2. Description of the Related Art

Printing data is prepared by an information terminal apparatus such as a personal computer, and sent to an image forming apparatus such as a printer to be printed. Printing data is managed as a print job composed of one page or a plurality of pages.

In the case of printing a plurality of print jobs, when printing of one of the print jobs is completed, or when printing is suspended for some reason, a printer notifies an information terminal apparatus which is a sender of the job, of a status of the job. Consequently, the user can check the status of each of the executed jobs through the information terminal apparatus.

A job operation condition notifying system disclosed in Japanese Unexamined Patent Publication JP-A 11-143651 (1999) gives unique job ID to each job, and notifies by associating the job ID with the execution condition or the like of the job, thereby enabling the user to accurately know the execution condition of a specific job.

An image processing apparatus disclosed in Japanese Unexamined Patent Publication JP-A 2004-157595 sends an e-mail with the thumbnail image of a top page attached to the demander of a print job when the print job is completed or suspended, thereby enabling the user to surely grasp what sort of job is the job that the user has been notified of.

Printing jobs include so-called related jobs, which are print jobs having a relation with each other, and the user often sends a plurality of print jobs to a printer without stopping in order to print the related jobs in succession.

Although the prior arts make it possible to know the execution condition or the like of an individual print job as described above, the user needs to remember which print jobs are related jobs in order to grasp the condition of all the related jobs, which is a great burden on the user.

### SUMMARY OF THE INVENTION

An object of the invention is to provide a printing control device and a printing apparatus that can reduce a burden on the user when printing related jobs, a printing control method, a printing control program, and a computer-readable recording medium recording the same.

The invention provides a printing apparatus that receives a print job from an information terminal apparatus and outputs the received print job by printing, the printing apparatus comprising: storing means for storing the received print job; outputting means for printing the stored print job; detecting means for detecting a status of the output of the print job; notifying means for notifying an information terminal apparatus which sent the print job, of the status detected by the detecting means; determining means for determining which of a plurality of print jobs stored in the storing means are related jobs having a relation with each other; and controlling means for controlling the notifying means So as to notify an information terminal apparatus which sent the print job, of that the print job is a related job, in the case of notifying an information terminal apparatus of a status of a print job determined to be a related job by the determining means, and to notify an information terminal apparatus which sent the print job, of a status of the print job detected by the detecting means, in the case of notifying an information terminal apparatus of a status of a print job not-determined to be a related job by the determining means.

According to the invention, the printing apparatus receives a print job from an information terminal apparatus, and outputs the received print job by printing.

The storing means stores the received print job, and the outputting means prints the stored print job The detecting means detects the status of output of the print job, and the notifying means notifies the information terminal apparatus which sent the print job, of the detected status.

In the case of notifying the information terminal apparatus of a status of a print job determined to be the related job by the determining means, the controlling means controls the notifying means so as to notify an information terminal apparatus which sent the print job, of that the print job is the related job. The controlling means controls the notifying means so as to notify, in the case of notifying an information terminal apparatus of a status of a print job not-determined to be a related job by the detecting means, an information terminal apparatus which sent the print job, of a status of the print job detected by the detecting means.

Consequently, even if the user does not remember which print jobs are related jobs, it is possible to know the status of the related jobs by causing the information terminal apparatus to output whether a print job is the related job or not, so that it is possible to reduce a burden on the user.

Further, in the invention, it is preferable that the storing means stores print jobs in the order of receipt; the outputting means outputs print jobs in the order of storage in the storing means; and when there is a print job that cannot be printed, the controlling means controls the outputting means so as to output a following print job first and, with respect to a print job determined to be the related job, controls the notifying means so as to notify the information terminal apparatus which sent the print job, of that the print job is the related job, regardless of the order of output.

Further, according to the invention, the storing means stores print jobs in the order of receipt and the outputting means outputs print jobs in the order of storage in the storing means. The print jobs are outputted on the basis of the data structure which is a so-called queue structure.

When there is a print job that cannot be printed, the controlling means executes a skip process to control the outputting means so as to output a following print job first and, as to a print job determined to be the related job, controls the notifying means so as to notify the information terminal apparatus which sent the print job, of that the print job is a related job, regardless of the order of output.

Consequently, it is possible to know the status of related jobs even if a skip process is executed, so that it is possible to reduce a burden on the user.

Furthermore, in the invention, it is preferable that with respect to a print job determined to be the related job, the notifying means notifies the information terminal apparatus which sent the print job, of that the print job is a related job and of a detected status of the print job.

Furthermore, according to the invention, as to a print job determined to be the related job, the notifying means notifies the information terminal apparatus which sent the print job, of that the print job is the related job and of a detected status.

Consequently, it is possible to know not only the status of related jobs but also the status of each print job.

Still further, in the invention, it is preferable that the printing apparatus further comprises completion detecting means for detecting that output of all related jobs is completed, wherein the notifying means notifies the information terminal apparatus which sent the related jobs, of that output of all the related jobs is completed, on the basis of a detection result of the completion detecting means.

Still further, according to the invention, the completion detecting means detects that output of all related jobs is completed, and the notifying means notifies the information terminal apparatus which sent the related jobs, of that output of all the related jobs is completed, on the basis of a detection result of the completion detecting means.

Consequently, even if the user does not remember which print jobs are related jobs, the user can know that all the related jobs are completed.

Still further, in the invention, it is preferable that the print job includes final job information that represents whether the print job is a final print job of related jobs or not; and in the case where output of a print job that includes final job information representing that the print job is a final print job of the related jobs is completed, the completion detecting means detects that output of all the related jobs is completed.

Still further, according to the invention, the print job includes final job information that represents whether the print job is a final print job of related jobs or not, and the completion detecting means detects that output of all the related jobs is completed in the case where output of a print job that includes final job information representing that the print job is a final print job of the related jobs is completed.

Consequently, it is possible to securely detect that output of all related jobs is completed.

Still further, in the invention, it is preferable that the completion detecting means detects that output of all related jobs is completed in the case where a print job of the related job is not stored in the storing means at the point when output of print jobs determined to be the related jobs is completed.

Still further, according to the invention, the completion detecting means detects that output of all related jobs is completed in the case where a print job of the related job is not stored in the storing means at the point when output of print jobs determined to be the related jobs is completed.

Consequently, it is possible to easily detect that output of all related jobs is completed without giving special information to print jobs.

Still further, in the invention, it is preferable that the completion detecting means detects that output of all related jobs is completed, in the case where a print job determined to be the related job is not received within a specified time, and a print job of the related job is not stored in the storing means at the point when output of print jobs determined to be the related jobs is completed.

Still further, according to the invention, the completion detecting means detects that output of all related jobs is completed, in the case where a print job determined to be the related job is not received within a specified time, and a print job of the related job is not stored in the storing means at the point when output of print jobs determined to be the related jobs is completed.

Consequently, it is possible to easily detect that output of all related jobs is completed without giving special information to print jobs.

Still further, the invention provides a printing control method for a printing apparatus that receives a print job from an information terminal apparatus and outputs the received print job by printing, the printing control method comprising: determining which of a plurality of print jobs stored are related jobs having a relation with each other; and in the case of notifying an information terminal apparatus which sent a print job determined to be the related job, of the status of the print job, notifying the information terminal apparatus which sent the print job, of that the print job is the related job, and in the case of notifying an information terminal apparatus of a status of a print job not-determined to be a related job, notifying an information terminal apparatus which sent the print job, of a status of the print job.

Still further, according to the invention, the printing control method is for the printing apparatus that receives a print job from the information terminal apparatus and outputs the received print job by printing It is determined which of a plurality of print jobs stored are related jobs having a relation with each other. In the case of notifying the information terminal apparatus which sent a print job determined to be the related job, of a status of the print job, the information terminal apparatus which sent a print job determined to be the related job is notified of that the print job is the related job. In the case of notifying an information terminal apparatus of a status of a print job not-determined to be a related job, an information terminal apparatus which sent the print job is notified of a status of the print job.

Consequently, even if the user does not remember which print jobs are related jobs, it is possible to know the status of the related jobs by causing the information terminal apparatus to output whether a print job is the related job or not, so that it is possible to reduce a burden on the user.

In the invention, it is preferable that the printing control method further comprises storing print jobs in the order of receipt; outputting print jobs in the order of storage; and when there is a print job that cannot be printed, outputting a following print job first and, with respect to a print job determined to be the related job, notifying the information terminal apparatus which sent the print job, of that the print job is the related job, regardless of the order of output.

According to the invention, it is possible to know the status of related jobs even if a skip process is executed, so that it is possible to reduce a burden on the user.

In the invention, it is preferable that the printing control method further comprises notifying, with respect to a print job determined to be the related job, the information terminal apparatus which sent the print job, of that the print job is a related job and of a detected status.

According to the invention, it is possible to know not only the status of related jobs but also the status of the respective print jobs.

Still further, in the invention, it is preferable that the printing control method further comprises detecting that output of all related jobs is completed; and notifying the information terminal apparatus which sent the related jobs, of that output of all the related jobs is completed.

According to the invention, even if the user does not remember which print jobs are related jobs, the user can know that all the related jobs are completed.

Still further, in the invention, it is preferable that the printing control method further comprises detecting that output of all the related jobs is completed when output of a print job that includes final job information representing that the print job is a final print job of the related jobs is completed.

According to the invention, it is possible to securely detect that output of all related jobs is completed.

Still further, in the invention, it is preferable that the printing control method further comprises detecting that output of all related jobs is completed in the case where a print job determined to be a related job is not stored at a time when output of the print job determined to be a related jobs is completed.

According to the invention, it is possible to easily detect that output of all related jobs is completed without giving special information to print jobs.

Still further, in the invention, it is preferable that the printing control method further comprises detecting that output of all related jobs is completed in the case where a print job determined to be a related job is not received within a specified time, and a print job determined to be a related job is not stored at a time when output of the print job determined to be a related jobs is completed.

According to the invention, it is possible to easily detect that output of all related jobs is completed without giving special information to print jobs.

Still further, the invention provides a printing control program for causing a computer to execute the aforementioned printing control method.

Still further, the invention provides a computer-readable recording medium on which the printing control program for causing a computer to execute the aforementioned printing control method is recorded.

Still further, according to the invention, it is possible to provide a printing control program for causing a computer to execute the aforementioned control method, and a computer-readable recording medium on which the printing control program is recorded.

### BRIEF DESCRIPTION OF THE DRAWINGS

Other and further objects, features, and advantages of the invention will be more explicit from the following detailed description taken with reference to the drawings wherein:

FIG. 1 is a schematic diagram of a printing system that comprises a multifunctional machine according to an embodiment of the invention;

FIG. 2 is a view showing the constitution of the print job information;

FIG. 3 is a block diagram showing the configuration of the multifunctional machine:

FIGS. 4A to 4C are views for explaining the notification process of a print job status;

FIGS. 5A to 5E are views showing examples of display of a job status by a PC;

FIG. 6 is a flowchart showing the notification process of a print job status; and

FIG. 7 is a flowchart showing the uncompleted related job determination process at step S1 shown in FIG. 6.

### DETAILED DESCRIPTION

Now referring to the drawings, preferred embodiments of the invention are described below.

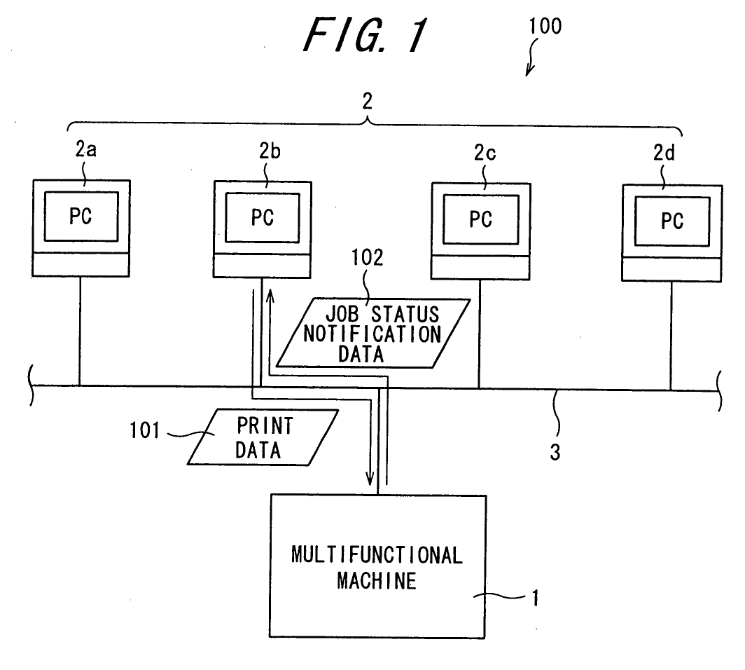

FIG. 1 is a schematic diagram of a printing system 100 that comprises a multifunctional machine 1 according to an embodiment of the invention.

The printing system 100 comprises the multifunctional machine 1 and personal computers (PCs) 2 (2a, 2b, 2c, 2d) as information terminal apparatuses, which are connected by a network cable 3 so as to be capable of performing data communication with each other.

The PC 2b sends print data 101 prepared with all sorts of application software or the like to the multifunctional machine 1, and the multifunctional machine 1 sends job status notification data 102 to the PC 2b that is the sender of the print data 101. The print data 101 is print job data that includes print job information described later and image data. The job status notification data 102 includes one of individual job suspension information, individual job completion information, related job suspension information, related job completion information, and job-of-related-jobs completion information.

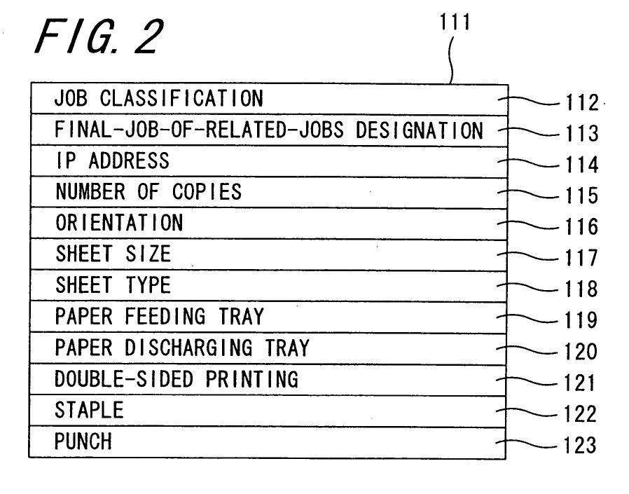

FIG. 2 is a view showing the constitution of the print job information 111.

As described above, the print job information 111 is sent from the PC 2 to the multifunctional machine 1 together with image data, and includes all sorts of conditions for printing.

In concrete, the print job information Ill is constituted of a job classification 112, final-job-of-related-jobs designation 113, an IP (Internet protocol) address 114, a number of copies 115, an orientation 116, a sheet size 117, a sheet type 118, a paper feeding tray 119, a paper discharging tray 120, double-sided printing 121, staple 122, and punch 123.

The job classification 112 is formed by an ID (identification) code or the like, and can be used for determining whether a job is a related job or not. The final-job-of-related-jobs designation 113 is final job information that represents whether print data including present print job information is a final job of related jobs or not. The IP address 114 is an IP address assigned to the sender PC 2 that sends print data including present printing information. The number of copies 115 represents the number of copies printed. The orientation 116 represents the printing direction (longitudinal direction or lateral direction) of a printing sheet for printing image data. The sheet size 1.17 represents the size of a printing sheet for printing image data, for example, A4, B5 and letter-size. The sheet type 118 represents the kind of a printing sheet for printing image data, for example, ordinary paper, glossy paper and an OHP (overhead projector) sheet. The paper feeding tray 119 represents which of a plurality of paper feeding trays provided in the multifunctional machine 1 is used. The paper discharging tray 120 represents which of a plurality of discharging trays provided in the multifunctional machine 1 is used. The double-sided printing 121 represents whether to perform double-sided printing or not. The staple 122 represents whether to execute a staple process in a finisher of the multifunctional machine 1. The punch 123 represents whether to execute a punch process in the finisher of the multifunctional machine 1.

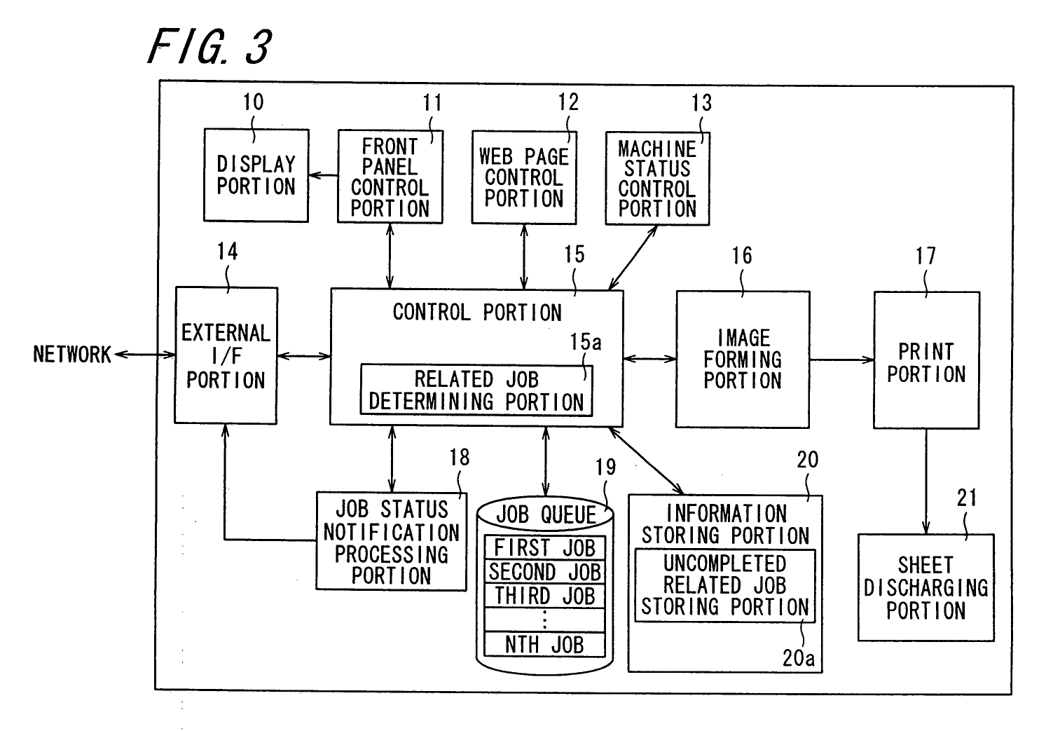

FIG. 3 is a block diagram showing the configuration of the multifunctional machine 1.

The multifunctional machine 1 is a printing apparatus that comprises a display portion 10, a front panel control portion 11, a Web page control portion 12, a machine status control portion 13, an external I/F (interface) portion 14, a control portion 15, an image forming portion 16, a print portion 17, a job status notification processing portion 18, a job queue 19, an information storing portion 20, and a sheet discharging portion 21.

The display portion 10 is realized by a liquid crystal display device or the like to display a menu screen, the status of the machine and so on, and is equipped with a touch panel or the like to have a function as inputting means by which the user inputs a direction and so on. The front panel control portion 11 controls a display content of the display portion 10, input by the touch panel and so on. The Web page control portion 12 creates a Web page that shows the setting of the machine, the status of print data and so on. The machine status control portion 13 detects a paper jam, a paper-out condition and so on, and controls the status of the machine. The external I/F portion 14 is connected with a cable for network connection, and performs transmission of all sorts of data with the PCs 2. The control portion 15 is realized by a CPU (central processing unit) or the like, and performs operation control of the whole multifunctional machine 1. Moreover, the control portion 15 is provided with a related job determining portion 15a serving as determining means for determining whether print jobs stored in the job queue 19 are related jobs or not. Control means, detecting means and completion detecting means are configured in the control portion 15.

The image forming portion 16 executes image processing such as color space conversion, region separation and filtering so that image data received from the PC 2 becomes suitable for printing. The print portion 17 is outputting means for outputting image data onto a printing sheet by the use of a method such as an electrophotographic method or an inkjet method. Moreover, the print portion 17 is equipped with a plurality of paper feeding trays for storing printing sheets. The job status notification processing portion 18 is notifying means for preparing the job status notification data 102 sent to the PC 2 that is the sender of the print data 101. The job queue 19 is storing means for storing the print data 101 received from the PC 2 as a print job. The job queue 19 stores a plurality of print jobs together with the order of reception (a first job, a second job, a third job, . . . and an Nth job in the order of receipt), and controls in the order of printing so as to print in the same order as the order of reception. The information storing portion 20 stores all sorts of information such as an operation control program, an image processing program and setting information of the machine, and is provided with an uncompleted related job storing portion 20a that stores a related job which has not been printed yet. The sheet discharging portion 21 is provided with a plurality of paper discharging trays that discharge printing sheets with images printed, and provided with a finisher.

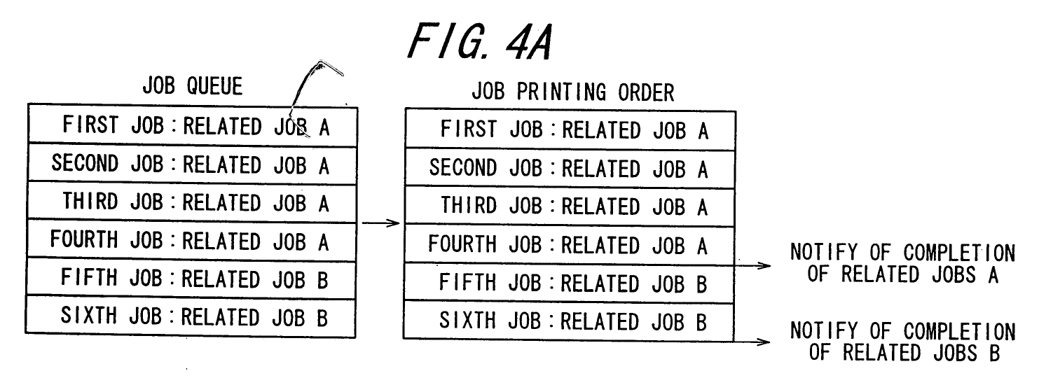

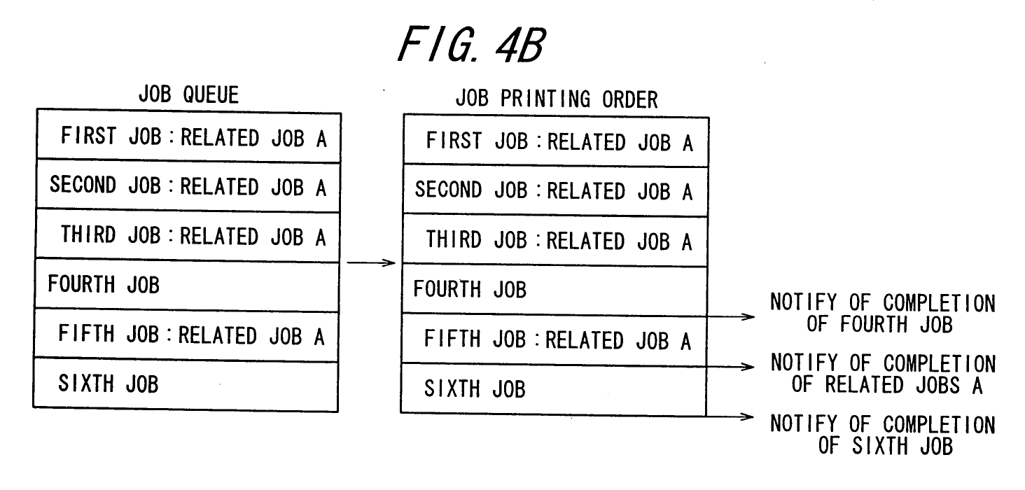

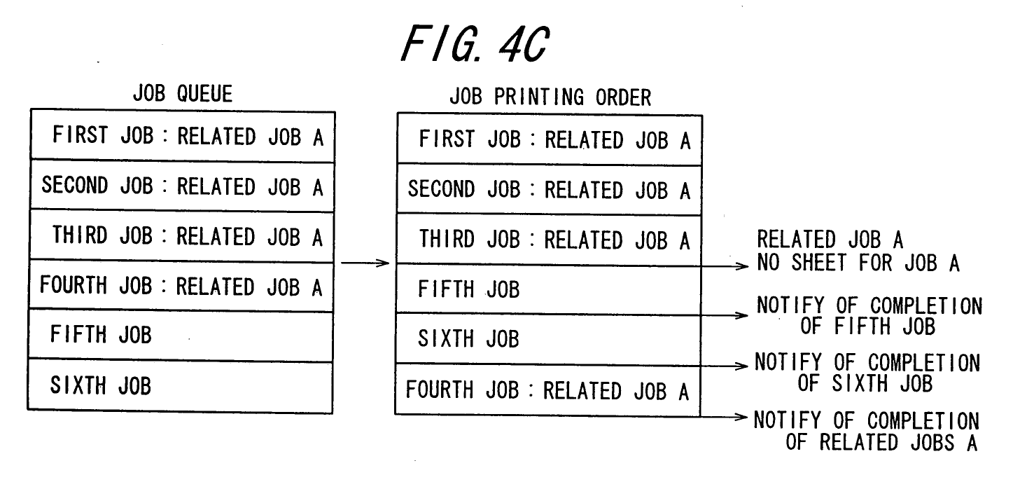

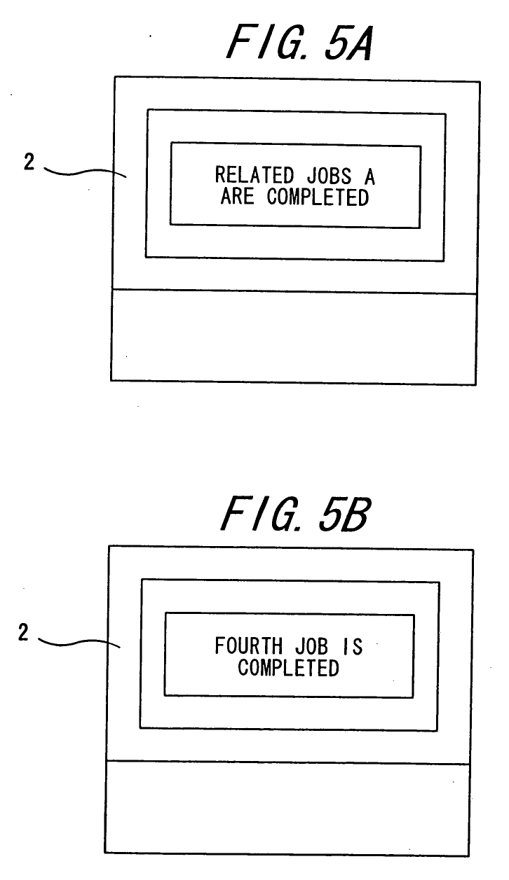

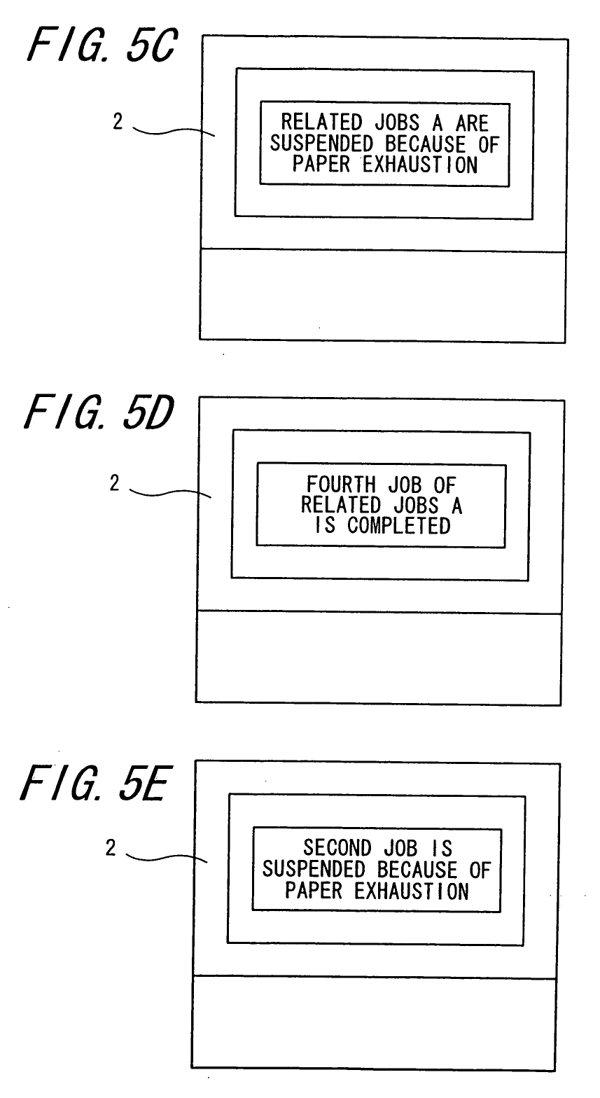

FIGS. 4A to 4C are views for explaining the notification process of a print job status. FIGS. 5A to 5E are views showing examples of display of a job status by the PC 2.

At first, in a first example of the process, as shown in FIG. 4A, six print jobs, that is, first to sixth jobs are stored in the job queue 19, and it is assumed that the first to fourth jobs are related jobs A that are related with each other and the fifth and sixth jobs are related jobs B that are related with each other.

Printing is performed in the order of storage in the job queue 19 and, at the point when printing of the fourth job is completed, the PC 2 which sent the related jobs A is notified of that printing of all the related jobs A is completed. In concrete, at the point when printing of the fourth job is completed, the job status notification processing portion 18 prepares related job completion information representing that printing of the related jobs A is completed, and sends as the job status notification data 102 to the PC 2. The PC 2 receives the job status notification data 102 and, for example, as shown in FIG. 5A, displays a message “Related jobs A are completed” representing that printing of the related jobs A is completed, thereby notifying the user.

Further, at the point when printing of the sixth job is completed, the job status notification processing portion 18 prepares related job completion information representing that printing of the related jobs B is completed, and sends as the job status notification data 102 to the PC 2. The PC 2 receives the job status notification data 102 and, for example, displays that printing of the related jobs B is completed, thereby notifying the user.

Consequently, even if the user does not remember which print jobs are related jobs, the user can know as the status of the related jobs that printing of all the related jobs is completed, so that it is possible to reduce a load on the user.

In a second example of the process, as shown in FIG. 48, six print jobs, that is, first to sixth jobs are stored in the job queue 19, and it is assumed that the first to third jobs and the fifth job are the related jobs A that are related with each other and the fourth job and the sixth job are not related jobs but independent individual jobs.

Printing is performed in the order of storage in the job queue 19. Since printing of all the related jobs A is not completed at the point when printing of the third job is completed, completion notification of the related jobs A is not performed, and at the point when printing of the fourth job is completed, the PC 2 which communicated the fourth job is notified of that printing of the individual fourth job is completed. In concrete, at the point when printing of the fourth job is completed, the job status notification processing portion 18 prepares individual job completion information representing that printing of the fourth job that is an individual job is completed, and sends as the job status notification data 102 to the PC 2. The PC 2 receives the job status notification data 102 and, for example, as shown in FIG. 5B, displays a message “Fourth job is completed” representing that printing of the fourth job is completed, thereby notifying the user.

Next, at the point when printing of the fifth job is completed, the PC 2 which sent the related jobs A is notified of that printing of all the related jobs A is completed. In concrete, at the point when printing of the fifth job is completed, the job status notification processing portion 18 prepares related job completion information representing that printing of the related jobs A is completed, and sends as the job status notification data 102 to the PC 2. The PC 2 receives the job status notification data 102 and, for example, displays that printing of the related jobs A is completed, thereby notifying the user.

Furthermore, at the point when printing of the sixth job is completed, the PC 2 which sent the sixth job is notified of that printing of the individual sixth job is all completed. In concrete, at the point when printing of the sixth job is completed, the job status notification processing portion 18 prepares individual job completion information representing that printing of the sixth job that is as an individual job is completed, and sends as the job status notification data 102 to the PC 2. The PC 2 receives the job status notification data 102 and, for example, displays that printing of the sixth job is completed, thereby notifying the user.

In a third example of the process, as shown in FIG. 4C, six print jobs, that is, first to sixth jobs are stored in the job queue 19, and it is assumed that the first to fourth jobs are the related jobs A that are related with each other and the fifth job and the sixth job are not related jobs but independent individual jobs. Here, it is assumed that printing sheets for printing the related jobs A and printing sheets for printing the fifth job and the sixth job are different in sheet size or sheet type.

Printing is performed in the order of storage in the job queue 19, and in the case where sheets are exhausted during printing of the fourth job and printing is suspended, the Pc 2 which communicated the fourth job is notified of that printing of the related jobs A is suspended. In concrete, at the point when printing of the fourth job is suspended, the job status notification processing portion 18 prepares related job suspension information representing that printing of the related jobs A is suspended, and sends as the job status notification data 102 to the PC 2. The PC 2 receives the job status notification data 102 and, for example, as shown in FIG. 5C, displays a message “Related jobs A are suspended because of paper exhaustion” representing that printing of the related jobs A is suspended, thereby notifying the user.

After that, the fifth job and the sixth job, sheets for which are not exhausted, are printed first. That is to say, skip printing is performed, and at the point when printing of the fifth job is completed, the PC 2 which communicated the fifth job is notified of that printing of the fifth job that is an individual job is completed, and at the point when printing of the sixth job is completed, the PC 2 which communicated the sixth job is notified of that printing of the sixth job that is an individual job is completed. In concrete, at the point when printing of the fifth job is completed, the job status notification processing portion 18 prepares individual job completion information representing that printing of the fifth job that is an individual job is completed, and sends as the job status notification data 102 to the PC 2. The PC 2 receives the job status notification data 102 and, for example, displays that printing of the fifth job is completed, thereby notifying the user. Moreover, at the point when printing of the sixth job is completed, the job status notification processing portion 18 prepares individual job completion information representing that printing of the sixth job that is an individual job is completed, and sends as the job status notification data 102 to the PC 2. The PC 2 receives the job status notification data 102 and, for example, displays that printing of the sixth job is completed, thereby notifying to the user.

Then, when printing sheets for printing the fourth job are resupplied during printing of the sixth job or after completion of printing of the sixth job, printing of the fourth job is started again. At the point when printing of the fourth job is completed, the PC 2 which sent the related jobs A is notified of that printing of all the related jobs A is completed. In concrete, at the point when printing of the fourth job is completed, the job status notification processing portion 18 prepares related job completion information representing that printing of the related jobs A is completed, and sends as the job status notification data 102 to the PC 2. The PC 2 receives the job status notification data 102 and, for example, displays that printing of the related jobs A is completed, thereby notifying the user.

In the process examples described above, notification of related jobs are only that all the related jobs are completed and that the related jobs are suspended, but it is also possible to notify the PC 2 which sent the related jobs A, every time one of the related jobs is completed, that printing of the one of the related jobs is completed. Explaining in concrete with reference to the first process example again, at the point when printing of the first job is completed, the job status notification processing portion 18 prepares job-of-related-jobs completion information representing that printing of the first job of the related jobs is completed, and sends as the job status notification data 102 to the PC 2. The PC 2 receives the job status notification data 102 and, for example, as shown in FIG. 5D, displays a message “First job of related jobs A is completed” representing that printing of the first job is completed, thereby notifying the user. After that, every time one of the second to sixth jobs is completed, notification is performed in the same manner as about the first job. In the case where the related jobs are completed simultaneously when one of the jobs is completed, for example, when the fourth job or the sixth job is completed, at the point when the job is completed, notification of completion of the related jobs may be performed after notification of completion of the job of the related jobs, or notification of completion of the job of the related jobs and notification of completion of the related jobs may be performed at a time, or only notification of completion of the related jobs may be performed.

Further, it is also possible to perform notification of suspension about an independent individual job. Explaining in concrete with reference to the first process example again, in the case where sheets are exhausted during printing of the second job, at the point when printing of the second job is suspended, the job status notification processing portion 18 prepares individual job suspension information representing that printing of the second job is suspended, and sends as the job status notification data 102 to the PC 2. The PC 2 receives the job status notification data 102 and, for example, as shown in FIG. 5E, displays a message “Second job is suspended because of paper exhaustion” representing that printing of the second job is suspended, thereby notifying the user.

Whether print jobs stored in the job queue 19 are related jobs or not is determined by the related job determining portion 15a. The methods of determining includes a method to determine on the basis of an ID code as the job classification 112 of the print job information 111 that print jobs having the same ID code are related jobs, or a method to determine that print jobs whose IP address 114 of the print job information 111 are the same are related jobs, and so on.

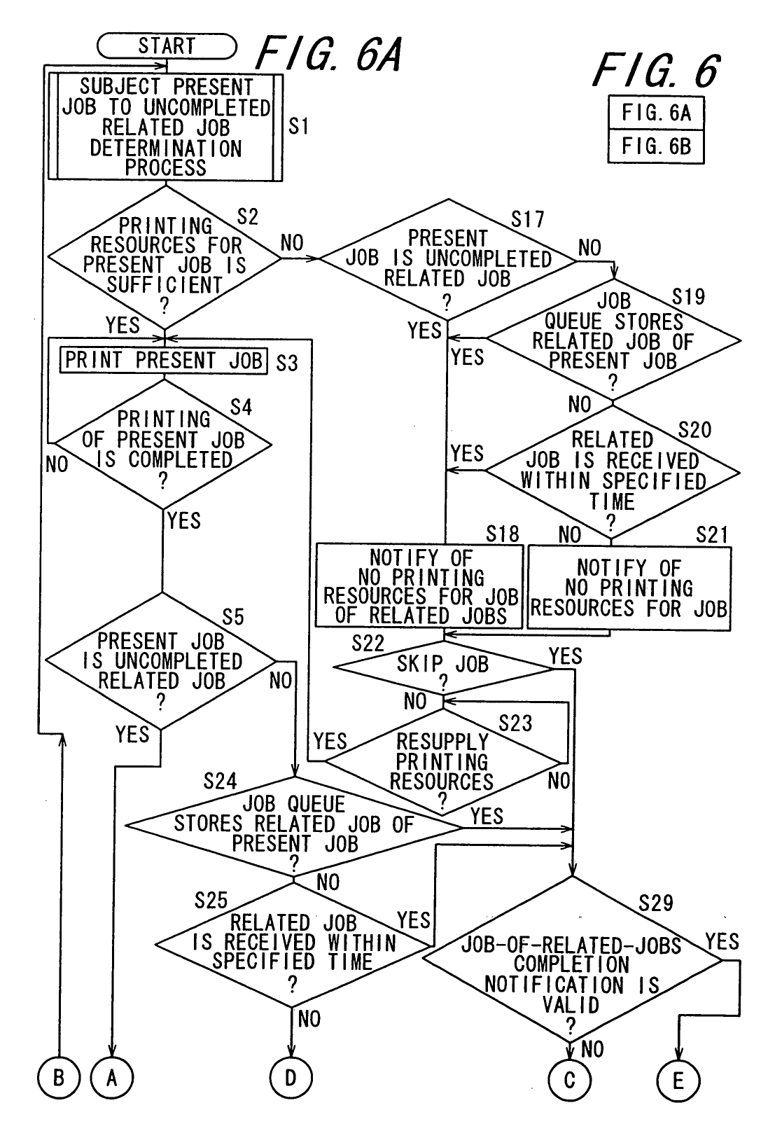

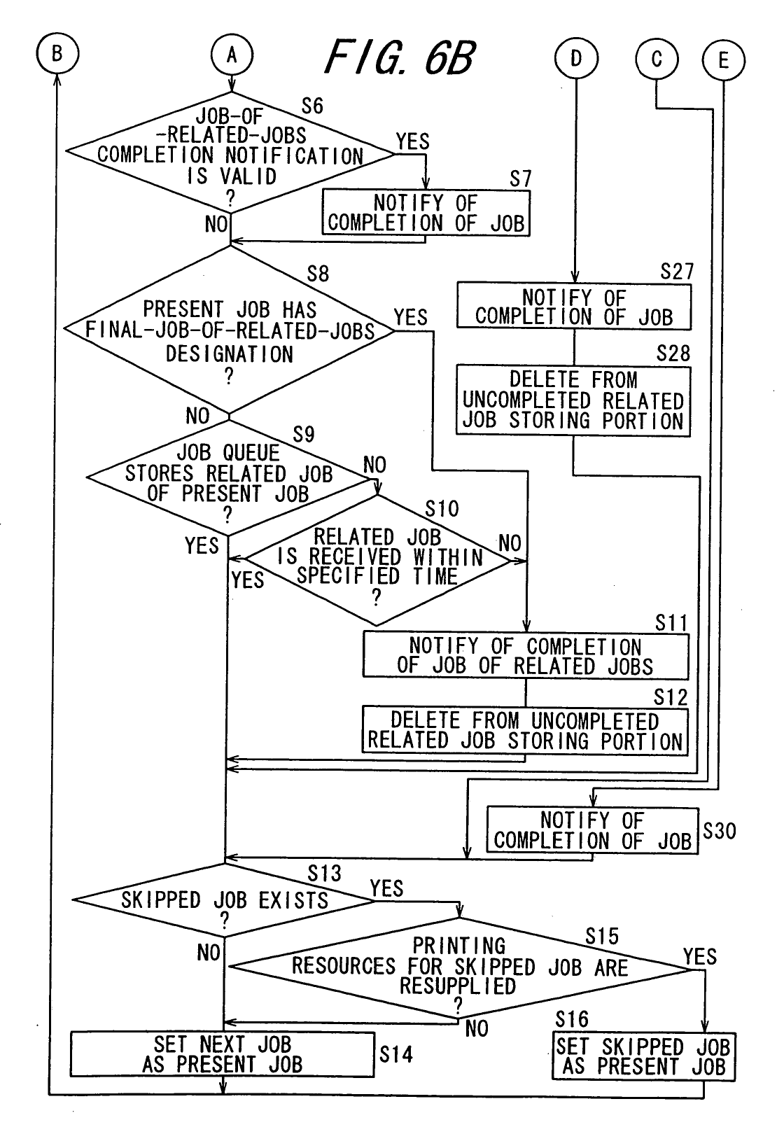

FIG. 6 is a flowchart showing the notification process of a print job status.

At first, at step S1, a job being processed at present (hereinafter, abbreviated to a present job) is subjected to an uncompleted related job determination process. At step S2, it is determined whether printing resources (printing sheets, ink, toner and so on) for printing the present job are sufficient or not. The process goes to step S3 when sufficient, and the process goes to step 317 when not sufficient. At step S3, printing of the present job is performed. At step S4, it is determined whether printing of the present job is completed or not. The process goes to step S5 when completed, and the process goes back to step 33 when not completed.

At step S5, it is determined whether the present job is an uncompleted related job or not. The process goes to step S6 in the case of an uncompleted related job, and the process goes to step S24 in the case of not an uncompleted related job. At step S6, it is determined whether job-of-related-jobs completion notification is valid or not. The job-of-related-jobs completion notification can be switched between valid and invalid by being set by the user in advance. When valid, the process goes to step S7 and the completion notification is performed, and when not valid, the process goes to step S8. At step S8, it is determined whether the present job is a final job of the related jobs or not. Whether the present job is a final job or not is determined by referring to the final-job-of-related-jobs designation 113 of the print job information 111. The process goes to step S11 in the case of a final job, and the process goes to step S9 in the case of not a final job. At step S9, it is determined whether a related job of the present job is stored in the job queue 19 or not. The process goes to step S13 when stored, and the process goes to step S10 when not stored. At step S10, it is determined whether the related job is received within a specified time or not The process goes to step S13 when received, and the process goes to step S11 when not received. At step S11, completion notification of the related jobs is performed. At step S12, the jobs stored in the uncompleted related job storing portion 20a are deleted.

Determination at step S9 and step S10 means that, even if it is determined on the basis of the final-job-of related-jobs designation 113 that the present job is not a final job, the present job is regarded as the final job of the related jobs in the case where the related job is not stored in the job queue 19 and the related job is not received within a specified time.

At step S13, it is determined whether a skipped job due to a skip process exists or not. When exists, the process goes to step S15. When not exist, the process goes to step S14, where a next job stored in the job queue 19 is set as a present job, and goes back to step S1. At step S15, it is determined whether printing resources for the skipped job are resupplied or not. When resupplied, the process goes to step S14. When not resupplied, the process goes to step S16, where the skipped job is set as a present job, and goes back to step S1.

In the case where printing resources are not sufficient at step S2, it is determined at step S17 whether the present job is an uncompleted related job or not. The process goes to step S18 in the case of an uncompleted related job, and the process goes to step S19 in the case of not an uncompleted related job. At step S18, notification that printing resources for a job of the related jobs are exhausted is performed. At step S19, it is determined whether a related job of the present job is stored in the job queue or not. The process goes to step S18 when stored, and the process goes to step S20 when not stored. At step S20, it is determined whether the related job is received within a specified time or not. The process goes to step S18 when received, and the process goes to step S21 when not received. At step S21, notification that printing resources for an individual job are exhausted is performed.

At step S22, it is determined whether to skip the job or not. The process goes to step S29 in the case of skipping, and the process goes to step S23 in the case of not skipping. Whether to perform the skip process or not can be decided by the user in advance. At step S23, it is determined whether the printing resources are resupplied or not. The process goes to step S3 when resupplied, and the process stands by when not resupplied. At step S29, it is determined whether job-of-related-jobs completion notification is valid or not. When valid, the process goes to step S30 and the completion notification is performed. When not valid, the process goes to step S13.

In the case where it is determined at step S5 that the present job is not an uncompleted related job, it is determined at step S24 whether a related job of the present job is stored in the job queue 19 or not. The process goes to step S29 when stored, and the process goes to step S25 when not stored. At step S25, it is determined whether the related job is received within a specified time or not. The process goes to step S29 when received, and the process goes to step S27 when not received. At step S27, completion notification of an individual job is performed. At step S28, the present job is deleted from the uncompleted related job storing portion 20a.

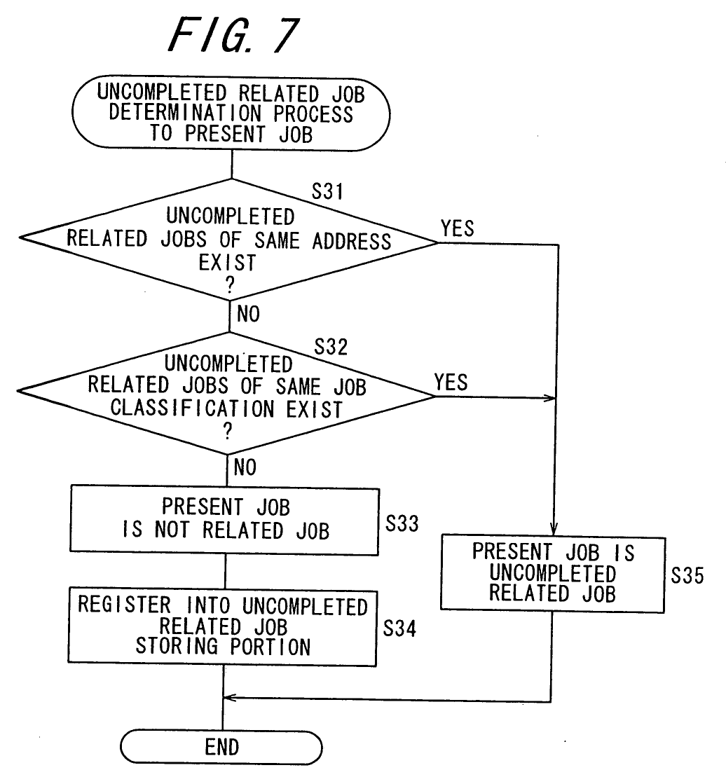

FIG. 7 is a flowchart showing the uncompleted related job determination process at step S1 shown in FIG. 6.

At step S31, it is determined whether print jobs already stored in the job queue 19 include such print jobs that have the same IP address 114 of the print job information 111. The process goes to step S35 when including, and the process goes to step S32 when not including. At step S32, it is determined whether the print jobs already stored in the job queue 19 include such print jobs that have the same job classification 112 of the print job information 111. The process goes to step S35 when including, and the process goes to step S33 when not including. At step S35, it is determined that the present job is an uncompleted related job. At step S33, it is determined that the present job is not a related job. At step 334, the job is registered into the uncompleted related job storing portion 20a.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A printing apparatus that receives a print job from an information terminal apparatus and outputs the received print job by printing, the printing apparatus comprising:
storing means for storing the received print job;
outputting means for printing the stored print job;
detecting means for detecting a status of the output of the print job;
notifying means for notifying an information terminal apparatus which sent the print job, of the status detected by the detecting means;
determining means for determining which of a plurality of print jobs stored in the storing means are related jobs having a relation with each other; and
controlling means for controlling the notifying means so as to notify an information terminal apparatus which sent the print job, of that the print job is a related job, in the case of notifying an information terminal apparatus of a status of a print job determined to be a related job by the determining means, and to notify an information terminal apparatus which sent the print job, of a status of the print job detected by the detecting means, in the case of notifying an information terminal apparatus of a status of a print job not-determined to be a related job by the determining means.

2. The printing apparatus of claim 1, wherein the storing means stores print jobs in the order of receipt,
the outputting means outputs print jobs in the order of storage in the storing means, and
when there is a print job that cannot be printed, the controlling means controls the outputting means so as to output a following print job first and, with respect to a print job determined to be the related job, controls the notifying means so as to notify the information terminal apparatus which sent the print job, of that the print job is the related job, regardless of the order of output.

3. The printing apparatus of claim 1, wherein with respect to a print job determined to be the related job, the notifying means notifies the information terminal apparatus which sent the print job, of that the print job is a related job and of a detected status of the print job.

4. The printing apparatus of claim 1, further comprising completion detecting means for detecting that output of all related jobs is completed,
wherein the notifying means notifies the information terminal apparatus which sent the related jobs, of that output of all the related jobs is completed, on the basis of a detection result of the completion detecting means.

5. The printing apparatus of claim 4, wherein the print job includes final job information that represents whether the print job is a final print job of related jobs or not, and
in the case where output of a print job that includes final job information representing that the print job is a final print job of the related jobs is completed, the completion detecting means detects that output of all the related jobs is completed.

6. The printing apparatus of claim 4, wherein the completion detecting means detects that output of all related jobs is completed in the case where a print job of the related job is not stored in the storing means at the point when output of print jobs determined to be the related jobs is completed.

7. The printing apparatus of claim 4, wherein the completion detecting means detects that output of all related jobs is completed, in the case where a print job determined to be the related job is not received within a specified time, and a print job of the related job is not stored in the storing means at the point when output of print jobs determined to be the related jobs is completed.

8. A printing control method for a printing apparatus that receives a print job from an information terminal apparatus and outputs the received print job by printing, the printing control method comprising:
determining which of a plurality of print jobs stored are related jobs having a relation with each other; and
in the case of notifying an information terminal apparatus which sent a print job determined to be the related job, of the status of the print job, notifying the information terminal apparatus which sent the print job, of that the print job is the related job, and in the case of notifying an information terminal apparatus of a status of a print job not-determined to be a related job, notifying an information terminal apparatus which sent the print job, of a status of the print job.

9. The printing control method of claim 8, further comprising:
storing print jobs in the order of receipt;
outputting print jobs in the order of storage; and
when there is a print job that cannot be printed, outputting a following print job first and, with respect to a print job determined to be the related job, notifying the information terminal apparatus which sent the print job, of that the print job is the related job, regardless of the order of output.

10. The printing control method of claim 8, further comprising notifying, with respect to a print job determined to be the related job, the information terminal apparatus which sent the print job, of that the print job is a related job and of a detected status.

11. The printing control method of claim 8, further comprising:
detecting that output of all related jobs is completed; and
notifying the information terminal apparatus which sent the related jobs, of that output of all the related jobs is completed.

12. The printing control method of claim 11, further comprising detecting that output of all the related jobs is completed when output of a print job that includes final job information representing that the print job is a final print job of the related jobs is completed.

13. The printing control method of claim 12, further comprising detecting that output of all related jobs is completed in the case where a print job determined to be a related job is not stored at a time when output of the print job determined to be a related jobs is completed.

14. The printing control method of claim 12, further comprising detecting that output of all related jobs is completed in the case where a print job determined to be a related job is not received within a specified time, and a print job determined to be a related job is not stored at a time when output of the print job determined to be a related jobs is completed.

15. A printing control program for causing a computer to execute a printing control method for a printing apparatus that receives a print job from an information terminal apparatus and outputs the received print job by printing, the printing control method comprising:
determining which of a plurality of print jobs stored are related jobs having a relation with each other; and
in the case of notifying an information terminal apparatus which sent a print job determined to be the related job, of the status of the print job, notifying the information terminal apparatus which sent the print job, of that the print job is the related job, and in the case of notifying an information terminal apparatus of a status of a print job not-determined to be a related job, notifying an information terminal apparatus which sent the print job, of a status of the print job.

16. A computer-readable recording medium on which is recorded a printing control program for causing a computer to execute a printing control method for a printing apparatus that receives a print job from an information terminal apparatus and outputs the received print job by printing, the printing control method comprising:
determining which of a plurality of print jobs stored are related jobs having a relation with each other; and
in the case of notifying an information terminal apparatus which sent a print job determined to be the related job, of the status of the print job, notifying the information terminal apparatus which sent the print job, of that the print job is the related job, and in the case of notifying an information terminal apparatus of a status of a print job not-determined to be a related job, notifying an information terminal apparatus which sent the print job, of a status of the print job.
